(19) United States
(12) Patent Application Publication
(10) Pub. No.: US 2010/0189946 A1
(43) Pub. Date: Jul. 29, 2010

(54) COMPOSITE MATERIAL INCLUDING NANOTUBES DISPERSED IN A FLUORINATED POLYMER MATRIX

(75) Inventors: Gilles Hochstetter, Bernay (FR); Michael Werth, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colomber (FR)

(21) Appl. No.: 12/666,654

(22) PCT Filed: Jun. 27, 2008
(86) PCT No.: PCT/FR2008/051185

§ 371 Date: Dec. 24, 2009

(30) Foreign Application Priority Data
Jun. 27, 2007 (FR) 0704618

(51) Int. Cl. B32B 1/08; C08L 27/12; C08K 3/28; C08K 3/38; C08K 3/32; C08K 3/04

(52) U.S. Cl. 428/36.9; 524/520; 524/424; 524/404; 524/415; 524/495; 977/742

(57) ABSTRACT

The invention relates to a composite material including nanotubes of a chemical element selected from the compounds of the elements of columns IIIa, IVa and Va of the periodic table, dispersed in a polymer matrix including (a) at least one fluorinated homo- or copolymer and (b) at least one fluorinated homo- or copolymer grafted with at least one carboxylic polar function. The invention also relates to the use of the composite material and to the use of at least one fluorinated homo- or copolymer grafted with at least one carboxylic polar function for increasing the tensile strength of a composite material containing the above nanotubes dispersed in a fluorinated polymer matrix.

The present invention relates to a composite material comprising nanotubes of at least one chemical element selected from the elements of columns IIIa, IVa and Va of the periodic table, dispersed in a polymer matrix comprising (a) at least one fluorinated homopolymer or copolymer and (b) at least one fluorinated homopolymer or copolymer grafted with at least one carboxylic polar function.

It also relates to the uses of this composite material, and also to the use of at least one fluorinated homopolymer or copolymer grafted with at least one carboxylic polar function for increasing the tensile strength of a composite material comprising the abovementioned nanotubes dispersed in a fluorinated polymer matrix.

Composite materials are the subject of intensive research since they have many functional advantages (lightness, mechanical strength, chemical resistance, scope in terms of shapes) which allow them to replace metal in very diverse applications.

They generally comprise a polymer matrix in which reinforcing fibers, such as glass fibers, carbon fibers or aramid fibers, are dispersed. The choice of a given matrix and of a given reinforcer is determined by the nature of the properties that it is desired to obtain according to the application envisioned.

Thus, pipes intended to transport hydrocarbons extracted from off-shore oilfields need to be able to be used at temperatures of at least 130° C. and at pressures of approximately 700 bar, while at the same time maintaining good mechanical strength, heat resistance and chemical resistance. The same is true of pipes used to convey certain hot and/or corrosive chemical fluids, such as sulfuric acid at approximately 140° C., 40% solutions of sodium hydroxide at approximately 90° C. or hot nitric acid.

For these applications, various suppliers propose the use of materials based on fluorinated polymers such as poly(vinylidene fluoride). These materials do not, however, always offer a sufficient lifetime at high temperature, in particular when they are subjected to stresses.

In order to remedy this drawback, it has become apparent to the Applicant that the introduction of nanotubes, in particular carbon nanotubes, into polymer materials (fluorinated or nonfluorinated) increases the hot creep resistance of these materials. However, it has been found that, in the case of fluorinated polymers, the tensile elongation at break, at ambient temperature, of the composites thus obtained is less than that of the nonreinforced polymer.

In addition, fluorinated polymers exhibit problems of compatibility with the carbon nanotubes used to reinforce them. The interfaces between the fluorinated polymer and the nanotubes consequently lack cohesion, which leads to the appearance of weak spots on the microscopic scale when the polymer matrix is subjected to a stress. Finally, the dispersion of the nanotubes in the fluorinated polymer is not always satisfactory, which can lead to the formation of aggregates detrimental to the desired properties for the final composite.

Consequently, there remains the need for cohesive and homogeneous composite materials which have not only good hot creep resistance, but also good tensile strength at ambient temperature, in particular for the manufacture of pressure sheaths for off-shore flexible pipes.

Now, after a considerable amount of research, the Applicant, to its credit, has developed a composite material which makes it possible to meet the above-mentioned need.

The subject of the present invention is thus a composite material comprising nanotubes of at least one chemical element selected from the elements of columns IIIa, IVa and Va of the periodic table, dispersed in a polymer matrix comprising (a) at least one fluorinated homopolymer or copolymer and (b) at least one fluorinated homopolymer or copolymer grafted with at least one carboxylic polar function.

The subject of the invention is also the use of at least one fluorinated homopolymer or copolymer grafted with at least one carboxylic polar function, for increasing the tensile strength of a composite material comprising nanotubes of at least one chemical element selected from the elements of columns IIIa, IVa and Va of the periodic table, dispersed in a fluorinated polymer matrix.

As a preamble, it is specified that, throughout this description, the expression “between” should be interpreted as including the limits mentioned.

The composite material according to the invention comprises, as first constituent, a polymer matrix containing at least one fluorinated homopolymer or copolymer, hereinafter denoted “fluorinated polymer”.

Preferably, this fluorinated polymer comprises at least 50 mol % of, and is advantageously constituted of, monomers of formula (I):

CFX═CHX′ (I)

where X and X′ independently denote a hydrogen or halogen in particular fluorine or chlorine) atom or a perhalogenated (in particular perfluorinated) alkyl radical. In formula (I), it is preferred that X═F and X′═H.

As examples of fluorinated polymers, mention may in particular be made of:
poly(vinylidene fluoride) (PVDF), preferably in α form,
copolymers of vinylidene fluoride with, for example, hexafluoropropylene (HFP), chlorotrifluoroethylene (CTFE), trifluoroethylene (VF3) or tetrafluoroethylene (TFE),
trifluoroethylene (VF3) homopolymers and copolymers,
fluoroethylene/propylene (FEP) copolymers,
copolymers of ethylene with fluoroethylene/propylene (FEP), tetrafluoroethylene (TFE), perfluoromethylvinyl ether (PMVE), chlorotrifluoroethylene (CTFE) or hexafluoropropylene (HFP), and
blends thereof,
   some of these polymers being in particular sold by the company Arkema under the name Kynar®, and the preferred polymers being those of a grade suitable for injection or for extrusion and preferably having a viscosity ranging from 100 to 2000 Pa·s, and more preferably 300 to 1200 Pa·s, measured at 230° C. under a shear gradient of 100 s⁻¹ by means of a capillary rheometer, such as the injection-grade Kynar® 710, 711 or 720 or the extrusion-grade Kynar® 740, 760, 50HD or 400HD, or else the VDF/HFP copolymers sold under the name Kynar® 2800 and 3120-50.

According to the invention, the fluorinated polymer is preferably poly(vinylidene fluoride) (PVDF).

In addition to this fluorinated polymer, the polymer matrix of the composite material according to the invention contains at least one fluorinated homopolymer or copolymer grafted with at least one carboxylic polar function, hereinafter denoted “grafted fluorinated polymer”.

This grafted fluorinated polymer can be obtained by grafting at least one carboxylic polar monomer, bearing, for example, at least one carboxylic acid or carboxylic anhydride function, onto a fluorinated polymer.

More specifically, this grafted fluorinated polymer may be prepared according to a method that comprises: (a) mixing, preferably in the molten state, for example by means of an extruder or of a mixer, a fluorinated polymer with a polar monomer bearing a carboxylic acid or carboxylic anhydride function, (b) optionally transforming this mixture into granules, a powder, a film or a sheet, (c) irradiating this mixture, optionally in the absence of oxygen (and, for example, in polyethylene bags) at a dose ranging from 1 to 15 Mrad of photon or electron irradiation, in order to graft the polar monomer onto the fluorinated polymer, and (d) optionally removing the residual polar monomer that has not reacted with the fluorinated polymer. A method of preparation of this type is in particular described in application EP-1 484 346.

The fluorinated polymer from which the grafted fluorinated polymer can be obtained may be any one of the fluorinated polymers described above, and in particular poly(vinylidene fluoride) (PVDF) or the copolymers of VDF and of HFP preferably containing at least 50% by weight of VDF units.

As polar monomers bearing a carboxylic function, mention may in particular be made of unsaturated monocarboxylic and dicarboxylic acids containing from 2 to 20 carbon atoms, and in particular from 4 to 10 carbon atoms, such as acrylic acid, methacrylic acid, maleic acid, fumaric acid, itaconic acid, citraconic acid, allylsuccinic acid, cyclohex-4-ene-1,2-dicarboxylic acid, 4-methylcyclohex-4-ene-1,2-dicarboxylic acid, bicyclo(2,2,1)hept-5-ene-2,3-dicarboxylic acid, x-methylbicyclo(2,2,1)hept-5-ene-2,3-dicarboxylic acid and undecylenic acid, and also the anhydrides thereof.

The grafted fluorinated polymer can therefore be obtained from at least one of these monomers. This fluorinated polymer is preferably grafted with maleic anhydride.

Such a grafted fluorinated polymer is in particular available from the company Arkema under the trade name Kynar® ADX 710, 711, 720 or 721.

The proportion by weight of the fluorinated polymer to the polar monomer that are used in the manufacture of the grafted fluorinated polymer usually ranges from 90:10 to 99.9:0.1.

The grafted fluorinated polymer may represent from 5% to 99% by weight, and preferably from 10% to 50% by weight, relative to the weight of the polymer matrix.

The fluorinated polymer and the grafted fluorinated polymer may be mixed either in the powdered state, or by compounding followed by granulation and grinding of the granules.

The polymer matrix used according to the invention may, moreover, contain various adjuvants, such as plasticizers, antioxidant stabilizers, light-stabilizers, coloring agents, impact-resistant agents, antistatic agents, fire-retardant agents and lubricants, and mixtures thereof.

In addition to the polymer matrix described above, the composite material according to the invention contains nanotubes of at least one chemical element selected from the elements of columns IIIa, IVa and Va of the periodic table.

These nanotubes may be based on carbon, on boron, on phosphorus and/or on nitrogen (borides, nitrides, carbides, phosphides) and, for example, constituted of carbon nitride, boron nitride, boron carbide, boron phosphide, phosphorus nitride and carbon boronitride.

The carbon nanotubes (hereinafter CNTs) are preferred for use in the present invention.

The nanotubes that can be used according to the invention may be of the single-wall, double-wall or multiwall type. The double-wall nanotubes may in particular be prepared as described by Flahaut et al. in Chem. Com. (2003), 1442. The multiwall nanotubes may, for their part, be prepared as described in document WO 03/02456.

The nanotubes normally have an average diameter ranging from 0.1 to 200 nm, preferably from 0.1 to 100 nm, more preferably from 0.4 to 50 nm, and better still from 1 to 30 nm, and advantageously have a length of from 0.1 to 10 μm. Their length/diameter ratio is advantageously greater than 10, and most commonly greater than 100. Their specific surface area is, for example, between 100 and 300 m²/g and their apparent density may in particular be between 0.05 and 0.5 g/cm³, and more preferably between 0.1 and 0.2 g/cm³. The multiwall nanotubes may, for example, comprise from 5 to 15 leaflets, and more preferably from 7 to 10 leaflets.

An example of crude carbon nanotubes is in particular commercially available from the company Arkema under the trade name Graphistrength® 0100.

These nanotubes may be purified and/or treated (for example oxidized) and/or ground and/or functionalized, before being used in the method according to the invention.

The grinding of the nanotubes may in particular be performed hot or cold, and be carried out according to known techniques implemented in devices such as ball mills, hammer mills, pug mills, knife mills, gas-jet mills or any other grinding system capable of reducing the size of the entangled mass of nanotubes. It is preferable for this grinding step to be performed using a gas-jet grinding technique, and in particular in an air-jet mill.

The crude or ground nanotubes may be purified by washing with a solution of sulfuric acid, so as to rid them of any residual inorganic and metallic impurities resulting from the method by which they were prepared. The weight ratio of nanotubes to sulfuric acid may in particular be between 1:2 and 1:3. The purification operation may, moreover, be carried out at a temperature ranging from 90 to 120° C., for example for a period of from 5 to 10 hours. This operation may advantageously be followed by steps in which the purified nanotubes are rinsed with water and dried.

The oxidation of the nanotubes is advantageously carried out by bringing the latter into contact with a solution of sodium hypochlorite containing from 0.5% to 15% by weight of NaOCl, and preferably from 1 to 10% by weight of NaOCl, for example in a weight ratio of nanotubes to sodium hypochlorite ranging from 1:0.1 to 1:1. The oxidation is advantageously carried out at a temperature below 60° C., and preferably at ambient temperature, for a period of time ranging from a few minutes to 24 hours. This oxidation operation may advantageously be followed by steps of filtration and/or centrifugation, washing and drying of the oxidized nanotubes.

The functionalization of the nanotubes can be carried out by grafting reactive units such as vinyl monomers at the surface of the nanotubes. The material making up the nanotubes is used as a radical polymerization initiator after having been subjected to heat treatment at more than 900° C., in an anhydrous medium devoid of oxygen, which is intended to remove the oxygenated groups from its surface. It is thus possible to polymerize methyl methacrylate or hydroxyethyl methacrylate at the surface of carbon nanotubes with a view to facilitating in particular their dispersion in the polymer matrix.

In the present invention, use is preferably made of optionally ground, crude nanotubes, i.e. nanotubes which are neither oxidized nor purified nor functionalized and which have undergone no other chemical treatment.

The nanotubes may represent from 0.5% to 30%, preferably from 0.5% to 10%, and even more preferably from 1% to 5%, of the total weight of the blend of fluorinated polymer and grafted fluorinated polymer.

It is preferred for the nanotubes and the polymer matrix to be mixed by compounding using customary devices such as twin-screw extruders or co-kneaders. In this method, polymer granules are typically mixed in the molten state with the nanotubes.

As a variant, the nanotubes may be dispersed, by any appropriate means, in the polymer matrix which is in solution in a solvent. In this case, the dispersion may be improved, according to one advantageous embodiment of the present invention, by using particular dispersion systems or particular dispersing agents.

Thus, in the case of a dispersion via the solvent process, the method for manufacturing the composite material according to the invention may comprise a step of dispersing the nanotubes in the polymer matrix by means of ultrasound or of a rotor-stator system.

Such a rotor-stator system is in particular sold by the company Silverson under the trade name Silverson® L4RT. Another type of rotor-stator system is sold by the company Ika-Werke under the trade name Ultra-Turrax®.

Yet other rotor-stator systems are constituted of colloidal mills, deflocculating turbomixers and high-shear mixers of rotor-stator type, such as the devices sold by the company Ika-Werke or by the company Admix.

The dispersing agents may in particular be chosen from plasticizers, which may themselves be chosen from the group constituted:
of alkyl esters of phosphates, of hydroxybenzoic acid (in which the alkyl group, which is preferably linear, contains from 1 to 20 carbon atoms), of lauric acid, of azelaic acid or of pelargonic acid,
of phthalates, especially dialkyl or alkylaryl phthalates, in particular alkylbenzyl phthalates, the linear or branched alkyl groups containing, independently, from 1 to 12 carbon atoms,
of adipates, in particular dialkyl adipates,
of sebacates, especially dialkyl sebacates, and in particular dioctyl sebacates, in particular when the polymer matrix contains a fluoropolymer,
of glycol benzoates or glyceryl benzoates,
of dibenzyl ethers,
of chloroparaffins,
of propylene carbonate,
of sulfonamides, in particular when the polymer matrix contains a polyamide, and especially arylsulfonamides in which the aryl group is optionally substituted with at least one alkyl group containing from 1 to 6 carbon atoms, such as benzenesulfonamides and toluenesulfonamides, which may be N-substituted or N,N-disubstituted with at least one alkyl group, which is preferably linear, containing from 1 to 20 carbon atoms,
of glycols, and
of mixtures thereof.

As a variant, the dispersing agent may be a copolymer comprising at least one anionic hydrophilic monomer and at least one monomer which includes at least one aromatic ring, such as the copolymers described in document FR-2 766 106, the ratio by weight of the dispersing agent to the nanotubes preferably ranging, in this case, from 0.6:1 to 1.9:1.

In another embodiment, the dispersing agent may be a vinylpyrrolidone homopolymer or copolymer, the ratio by weight of the nanotubes to the dispersing agent preferably ranging, in this case, from 0.1 to less than 2.

In yet another embodiment, the dispersion of the nanotubes in the polymer matrix may be improved by bringing said nanotubes into contact with at least one compound A which may be chosen from various polymers, monomers, plasticizers, emulsifiers, coupling agents and/or carboxylic acids, the two components (nanotubes and compound A) being mixed in the solid state, or the mixture being in pulverulent form, optionally after elimination of one or more solvents.

The composite material as described above is of interest in various applications.

The subject of the present invention is also the use of this composite material for manufacturing hollow components such as tubes, sheaths or connectors intended in particular to contain or transport hot and optionally pressurized and/or corrosive fluids, and in particular pipes for transporting hydrocarbons, such as sheaths for off-shore flexible pipes; pipes for transporting fluids produced or used in the chemical industry; or injection-molded connectors for pressurized pipework.

The pipes and hollow components above may, for example, be manufactured by extrusion or by injection-molding of the composite according to the invention.

In the abovementioned uses, the composite material according to the invention may constitute the internal layer of a multilayer pipe, in contact with the fluid to be contained or transported, the other layers, which are the external layer and optionally the intermediate layer(s), being constituted of other materials such as a polyolefin or a polyamide.

For use as a pressure sheath for an off-shore flexible pipe, the composite material according to the invention preferably comprises, as fluorinated polymer, a fluorinated copolymer having a melting point of between 140° C. and 170° C., preferably between 160° C. and 170° C., and for example in the region of 165° C., so as to obtain good hot-creep and blistering resistance in the event of rapid decompression linked to an interruption of production (typically, 130° C. from 750 to 2500 bar, for example for a decompression rate of 70 mbar/min) or a VDF homopolymer having a viscosity of greater than 12 kilopoises (kP) measured at 100 s⁻¹ and at 232° C. (ASTM D3835), which is advantageously of extrusion grade, preferably plasticized and impact-reinforced by means of core-shell systems so as to obtain, in particular, good cold mechanical strength (impact resistance, fatigue resistance).

For use as a smooth tube or injection-molded connector subjected to an internal pressure and/or transporting a hot fluid (typically 90° C.), which is possibly corrosive, such as sodium hydroxide, a VDF homopolymer, preferably of extrusion grade (viscous), will, for example, be selected as fluorinated polymer for the manufacture of tubes or an injection-grade (fluid) VDF homopolymer will, for example, be selected as fluorinated polymer for the manufacture of connectors.

The invention will now be illustrated by the following nonlimiting examples, taken in combination with the attached figures in which:

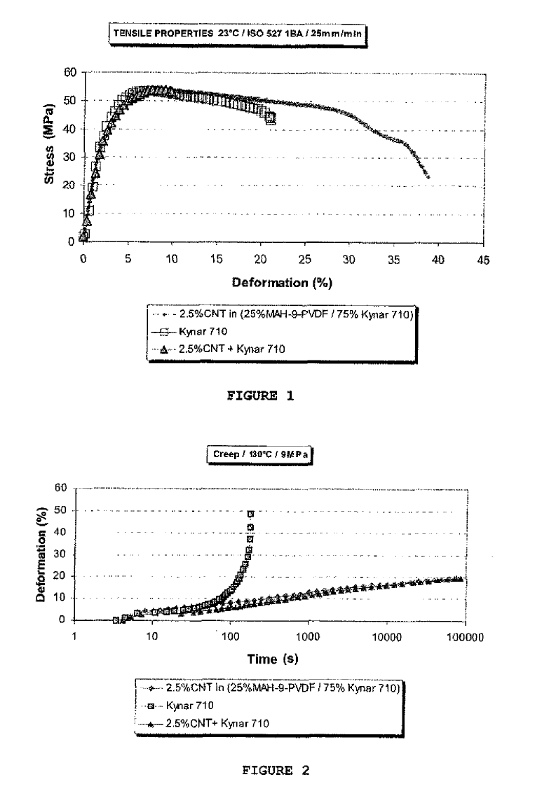

FIG. 1 illustrates the tensile strength (deformation as a function of stress) of test pieces of composite materials containing or not containing a grafted fluorinated polymer, and

FIG. 2 illustrates the hot creep resistance of these same test pieces.

### EXAMPLES

### Example 1

### Effect of the Addition of a Grafted Fluorinated Polymer on the Tensile Strength of a Fluorinated Polymer Matrix Containing Carbon Nanotubes

A VDF homopolymer (Kynar® 710 provided by Arkema) in solution in DMF (dimethylformamide) was blended with a fluorinated polymer (Kynar® 710) grafted with maleic anhydride, in a proportion by weight of PVDF to the grafted fluorinated polymer of 75:25. Carbon nanotubes (CNTs) (Graphistrength® C100) were then added to this blend in a proportion of 2.5% by weight relative to the weight of the polymer blend.

A test piece was manufactured from this mixture, by compression of powders obtained after evaporation of the solvent, and was subjected to tensile testing at 23° C. according to ISO standard 527 under the following conditions: 1BA; 25 mm/min.

This test piece was compared with test pieces that were similar, but the polymer matrix of which was constituted only of the fluorinated polymer respectively with and without CNTs.

The results of this tensile testing are given in FIG. 1, from which it emerges that:
the addition of CNTs makes the fluorinated polymer brittle since the elongation at break goes from approximately 20% to 10%,
the introduction of the grafted fluorinated polymer makes it possible to reinforce the polymer matrix and to improve the tensile strength thereof, which is reflected by an increase in the extension at break from 20% to 38%.

### Example 2

### Effect of the Addition of a Grafted Fluorinated Polymer on the Creep Resistance of a Fluorinated Polymer Matrix Containing Carbon Nanotubes

### Protocol:

The creep resistance of the test pieces prepared as described in example 1 was measured.

The general protocol for this test was the following. The test consists in applying a constant tensile force to the material tested and in measuring the change in the resulting deformation over time. For a given force, the greater the creep resistance of the material, the smaller the deformation over time. This force is expressed as stress, with the force being related to the initial cross section of the test piece, so as to do away with the effect of the geometry of the test piece used. This test piece is typically an ISO 529-type tensile test piece. The deformation is measured by means of a displacement sensor (typically of LVDT type) attached to the column of the tensile test piece and the deformation over time is recorded by acquisition on a computer, at a typically logarithmic frequency so as to take into account the slowing down of the process over time and so as not to needlessly saturate the acquisition system. The testing machine used may be a dynamometer such as those used for standard tensile testing, provided that it is possible to correctly servo-control the system for moving the mobile crosspiece of the machine to which the test piece is attached, in order to be capable of performing the testing while imposing a constant force over time. This means that the movement of the crosspiece of the machine must be continuous and even, so as to compensate for the elongation of the test piece. Another, simpler, system which consists in loading the test piece with a dead weight may be used.

### Results:

As shown in FIG. 2, the CNTs greatly increase the creep resistance of the fluorinated polymer matrix at 130° C. The incorporation of a grafted fluorinated polymer does not modify the hot-effectiveness of the CNTs.

It therefore emerges from these examples that the addition of the grafted fluorinated polymer makes it possible to conserve or even improve the mechanical properties of the fluorinated polymer at ambient temperature, without losing the advantageous properties conferred, under hot conditions, on the fluorinated polymer by the nanotubes.

1. A composite material comprising nanotubes of at least one chemical element selected from the elements of columns IIIa, IVa and Va of the periodic table, dispersed in a polymer matrix comprising (a) at least one fluorinated homopolymer or copolymer and (b) at least one fluorinated homopolymer or copolymer grafted with at least one carboxylic polar function.

2. The material as claimed in claim 1, wherein the fluorinated homopolymer or copolymer comprises at least 50 mol % of monomers of formula (I):
CFX═CHX′ (I)
where X and X′ independently denote a hydrogen or halogen atom or a perhalogenated alkyl radical.

3. The material as claimed in claim 1, wherein the fluorinated homopolymer or copolymer is selected from the group consisting of:
poly(vinylidene fluoride) (PVDF),
copolymers of vinylidene fluoride with, hexafluoropropylene (HFP), chlorotrifluoroethylene (CTFE), trifluoroethylene (VF3) or tetrafluoro-ethylene (TFE),
trifluoroethylene (VF3) homopolymers and copolymers,
fluoroethylene/propylene (FEP) copolymers,
copolymers of ethylene with fluoroethylene/propylene (FEP), tetrafluoroethylene (TFE), perfluoromethylvinyl ether (PMVE), chlorotrifluoroethylene (CTFE) or hexafluoropropylene (HFP), and
blends thereof.

4. The material as claimed in claim 3, wherein the fluorinated is a homopolymer or copolymer of poly(vinylidene fluoride).

5. The material as claimed in claim 1, wherein the grafted fluorinated homopolymer or copolymer is obtained from a fluorinated polymer 4. selected from the group consisting of monomers of formula (I):
CFX═CHX′ (I)
where X and X′ independently denote a hydrogen or halogen atom or a perhalogenated alkyl radical;
poly(vinylidene fluoride) (PVDF);
copolymers of vinylidene fluoride with hexafluoropropylene (HFP), chlorotrifluoroethylene (CTFE), trifluoroethylene (VF3) or tetrafluoroethylene (TFE);
trifluoroethylene (VF3) homopolymers and copolymers;
fluoroethylene/propylene (FEP) copolymers;
copolymers of ethylene with fluoroethylene/propylene (FEP);
tetrafluoroethylene (TFE), perfluoromethylvinyl ether (PMVE), chlorotrifluoroethylene (CTFE) or hexafluoropropylene (HFP); and
blends thereof.

6. The material as claimed in claim 1, wherein the grafted fluorinated homopolymer or copolymer can be obtained from at least one monomer selected from the group consisting of: unsaturated monocarboxylic and dicarboxylic acids containing from 2 to 20 carbon atoms, acrylic acid, methacrylic acid, maleic acid, fumaric acid, itaconic acid, citraconic acid, allylsuccinic acid, cyclohex-4-ene-1,2-dicarboxylic acid, 4-methylcyclohex-4-ene-1,2-dicarboxylic acid, bicyclo(2,2,1)hept-5-ene-2,3-dicarboxylic acid, x-methylbicyclo(2,2,1)hept-5-ene-2,3-dicarboxylic acid and undecylenic acid, and the anhydrides thereof.

7. The material as claimed in claim 1, wherein the fluorinated homopolymer or copolymer grafted with a carboxylic polar function is grafted with maleic anhydride.

8. The material as claimed in claim 1, wherein the grafted fluorinated polymer represents from 5% to 99% by weight, relative to the weight of the polymer matrix.

9. The material as claimed in claim 1, wherein the nanotubes are constituted of carbon nitride, boron nitride, boron carbide, boron phosphide, phosphorus nitride or carbon boronitride.

10. The material as claimed in claim 9, wherein the nanotubes are carbon nanotubes.

11. The material as claimed in claim 1, wherein the nanotubes represent from 0.5% to 30% of the total weight of the fluorinated homopolymer or copolymer and of the grafted fluorinated polymer.

12. The material as claimed in claim 1 comprising hollow components.

13. (canceled)

14. The material as claimed in claim 2, wherein said X and X′ independently denote a hydrogen or fluorine or chlorine atom or a perfluorinated alkyl radical.

15. The material as claimed in claim 8, wherein said grafted fluorinated polymer represents from 10% to 50% by weight, relative to the weight of the polymer matrix.

16. The material as claimed in claim 11, wherein the nanotubes represent from 0.5% to 10% of the total weight of the fluorinated homopolymer or copolymer and of the grafted fluorinated polymer.

17. The material of claim 12, wherein said hollow component is selected from the group consisting of tubes, sheaths, and connectors.

18. The material of claim 17, wherein said hollow components are intended to contain or transport hot and optionally pressurized and/or corrosive fluids.

19. The material of claim 18, wherein said hollow components are selected from the group consisting of pipes for transporting hydrocarbons, sheaths for off-shore flexible pipes; pipes for transporting fluids produced or used in the chemical industry; and injection-molded connectors for pressurized pipework.
